(19) United States
(12) Patent Application Publication
(10) Pub. No.: US 2006/0079699 A1
(43) Pub. Date: Apr. 13, 2006

(54) Intermediate compounds and methods for synthesizing chemiluminescent dioxetane substrates

(76) Inventors: Brooks Edwards, Cambridge, MA (US); Rouh-Rong Juo, Allston, MA (US); Alison L. Sparks, N. Andover, MA (US)

Correspondence Address: MERCHANT & GOULD PC, P.O. BOX 2903, MINNEAPOLIS, MN, 55402-0903, US

(21) Appl. No.: 11/210,967

(22) Filed: Aug. 25, 2005

Related U.S. Application Data
(60) Provisional application No. 60/604,814, filed on Aug. 27, 2004.

(51) Int. Cl. C07F 9/655

(52) U.S. Cl. 549/218

(57) ABSTRACT

Methods for synthesizing 1,2-dioxetane compounds and intermediate compounds useful in the synthesis of these dioxetane compounds are described. The methods and intermediates allow for the efficient production of dioxetane substrates having electron withdrawing groups via a Homer Emmons coupling route.

This application claims the benefit of Provisional U.S. Patent Application No. 60/604,814, filed Aug. 27, 2004, which is incorporated by reference herein in its entirety.

### INTRODUCTION

The present application relates generally to the synthesis of 1,2-dioxetane compounds and to intermediates for the synthesis of such compounds.

Chemiluminescent dioxetane enzyme substrates are generally manufactured in 7-8 steps, with assembly of the carbon skeleton via a Horner Emmons coupling. Some of the key intermediates include a benzylphosphonate, an enol ether phenol, and a phenyl triester phosphate 1,2-dioxetane. This manufacturing process can, in many cases, be readily scaleable from gram to kilo batch synthesis, and has been the basis for the production of various commercialized dioxetane substrates including AMPPD, CSPD, CDP-Star®, Gal-Star®, and ADP-Star®.

There still exists a need, however, for improved synthetic processes for commercial production of dioxetane substrates, particularly for dioxetane substrates with strong electron withdrawing substituents attached to the dioxetane ring.

### BRIEF DESCRIPTION OF THE DRAWINGS

The skilled artisan will understand that the drawings, described below, are for illustration purposes only. The drawings are not intended to limit the scope of the present teachings in any way.

FIG. 1 illustrates a generalized reaction scheme for the synthesis of CDP-Star® dioxetane substrate.

FIG. 2 illustrates the electron withdrawing effect of a tri-ester phosphate group versus a monosodium diester phosphate group on the enol ether functionality of TFE-CDP-Star® dioxetane substrate photooxygenation intermediates.

FIG. 3 illustrates steps involved in the synthesis of TFE-CDP-Star® dioxetane substrate according to some embodiments of the invention.

### DESCRIPTION OF VARIOUS EMBODIMENTS

The present application is directed to methods for synthesizing 1,2-dioxetane compounds and to intermediate compounds useful in the synthesis of these dioxetane compounds. The 1,2-dioxetane compounds can have a structure represented by formula (I) below: 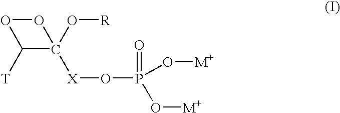
wherein R can be an alkyl, aryl, aralkyl or cycloalkyl group having 1-20 carbon atoms optionally comprising 1-5 halogen atoms each independently either F, Cl, Br or I; T can be a stabilizing group; M can be an alkali metal or ammonium, pyridinium or peralkylammonium group; and X can be an aromatic, light-emitting fluorophore-forming group capable of absorbing energy to form an excited energy state from which it emits optically detectable energy to return to its original energy state.

In the above formula, “T” represents a stabilizing group that prevents the dioxetane compound from decomposing before the oxygen-phosphorous bond in the labile ring substituent attached to X is intentionally cleaved. Exemplary stabilizing groups include an aryl group, a heteroatom group, or a substituted cycloalkyl group having from 6 to 12 carbon atoms, inclusive, and having one or more alkoxy or alkyl substituents containing from 1 to 7 carbon atoms, inclusive (e.g., 4-tertbutyl-1-methyl-cyclohex-1-yl). The above groups can be used in any combination to satisfy the valence of the dioxetane ring carbon atom to which they are attached. Alternatively, T may be a cycloalkylidene group bonded to the 3-carbon atom of the dioxetane ring through a spiro linkage and having from 5 to 12 carbon atoms, inclusive, which may be further derivatized with one or more substituents which can be alkyl or aralkyl groups having from 1 to 7 carbon atoms, inclusive, or a heteroatom group which can be an alkoxy group having from 1 to 12 carbon atoms, inclusive, such as methoxy or ethoxy (e.g., 4-tertbutyl-2,2,6,6-tetramethylcyclohexyliden-1-yl). The stabilizing group can be a fused polycycloalkylidene group bonded to the 3-carbon atom of the dioxetane ring through a carbon-carbon or a spiro linkage and having two or more fused rings, each having from 3 to 12 carbon atoms, inclusive (e.g., an adamant-2-ylidene or an adamant-2-yl group), which may additionally contain unsaturated bonds or 1,2 fused aromatic rings, or a substituted or unsubstituted alkyl group having from 1 to 12 carbon atoms, inclusive, such as tertiary butyl or 2-cyanoethyl, or an aryl or substituted aryl group such as carboxyphenyl, or a halogen group such as chloro, bromo, iodo or a heteroatom group which can be a hydroxyl group or a substituted or unsubstituted alkoxy or aryloxy group having from 1 to 12 carbon atoms, inclusive, such as an ethoxy, hydroxyethoxy, methoxyethoxy, carboxymethoxy, or polyethyleneoxy group. T can also be a diisopropyl group.

Any of the aforementioned groups on the dioxetane compounds (i.e., R, T or X) may also be deuterated.

An exemplary 1,2-dioxetane compound is TFE-CDP-Star® which has a structure as set forth below: 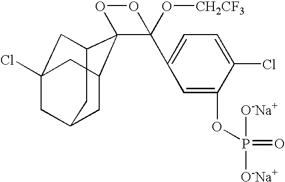
TFE-CDP-Star® enables sensitive detection of genes, in various solid support microarray formats. As with other dioxetanes, the signal from this chemiluminescent dioxetane can be readily enhanced by polycationic enhancers and nylon surfaces for superior detection. For example, TFE-CDP-Star®, gives superior sensitivity detection in solid support assay designs, and may also offer detection sensitivity advantages in other solution and solid support assay designs.

A dioxetane compound having the formula: 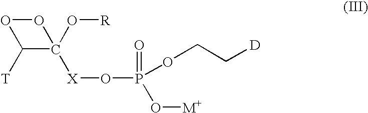
is also provided wherein R, T, and X are defined as set forth above and wherein D is chosen such that the proton alpha to D is acidic and can be deprotonated by a base resulting in beta-elimination of the ethyl-D group as an ethylene-D group thereby leaving an oxyanion or hydroxyl group. This compound can be used as an intermediate in the manufacture of TFE-CDP-Star®.

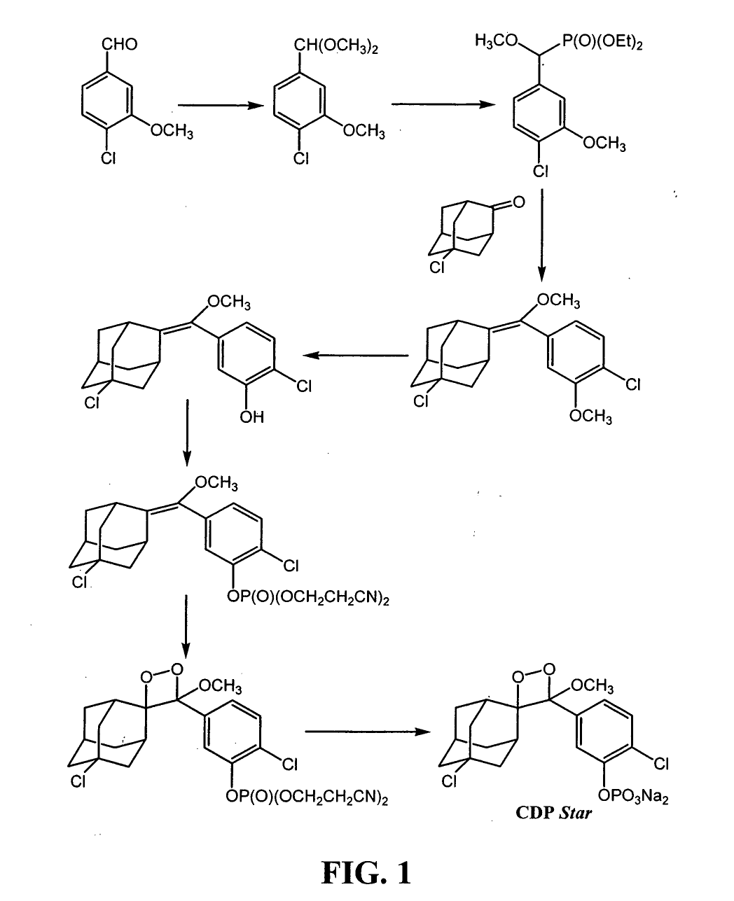

A standard manufacturing process for chemiluminescent dioxetane synthesis is shown in FIG. 1 which illustrates a generalized reaction scheme for the synthesis of CDP-Star®. This general process, however, when adapted for the production of TFE-CDP-Star®, was found to be less efficient for the production of the substrate. Several changes in the synthesis of the intermediates were found to substantially increase production yields resulting in correspondingly lower production times and costs. First, the formation of the bis(trifluoroethoxy) benzyl acetal was modified. In addition, the photooxygenation of the intermediate enol ether was reworked. These modifications allowed the use of the Horner Emmons dioxetane synthesis process.

For most dioxetane substrates, the acetal is usually obtained by standard acetalization of benzaldehyde analogues, using trimethylorthoformate in acidic methanol. In the case of TFE-CDP-Star synthesis, however, bis(trifluoroethoxy) benzyl acetal formation in acidic conditions did not produce a clean product. Modifying the synthesis using Ag⁺ assisted nucleophilic attack of a dichloroacetal by trifluoroethoxide under basic conditions, however, was found to yield the desired bis(trifluoroethoxy)benzyl acetal.

A second change to the synthesis outlined in FIG. 1 involved modifying the enol ether intermediate for photooxygenation from the triester phosphate to the monosodium diester phosphate. In general, photooxygenation of electron-rich alkenes, such as enol ethers, with singlet oxygen affords very clean formation of dioxetanes in excellent yields (>80%). The TFE-CDP-Star® triester phosphate analogue, however, presented reduced electron density in the enol ether function, due to the electron withdrawing effect of the trifluoroethoxy group. This reduced electron density can result in very prolonged phtooxygenation times and increased product decomposition.

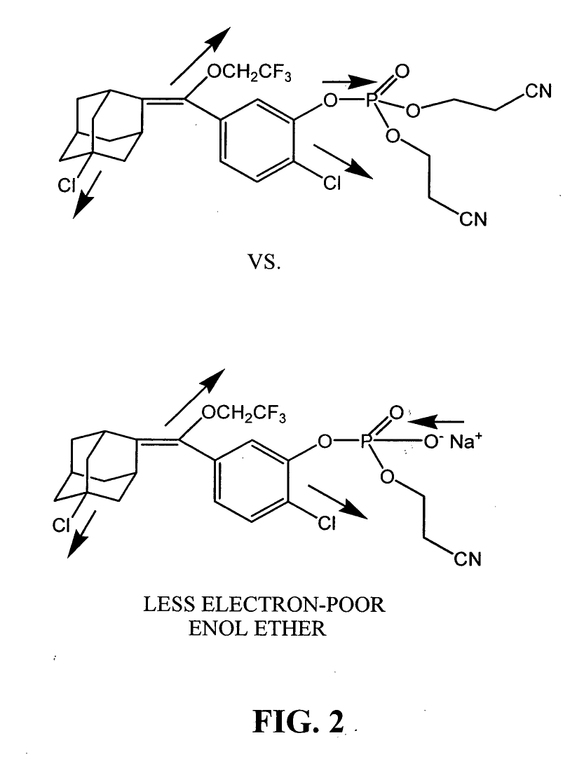

To mitigate the loss of electron density in the double bond, the photooxygenation intermediate was modified to the monosodium phosphate anion to restore electron density with the presence of the anion. FIG. 2 illustrates the electron withdrawing effect of various functional groups on the electron density of the enol-ether function for the TFE-CDP-Star® triester phosphate analogue (top) versus the corresponding monosodium diester phosphate analogue (bottom). The monosodium diester phosphate enol ether was obtained by base titration of the triester phosphate prior to photooxygenation, using 1.0 to 1.5 equivalents of base based on acidic impurities.

Changing the photooxygenation intermediate was found to increase the photooxygenation output from 0.5 gm TFE-CDP-Star in 12 hours, to 2.0+ gm TFE-CDP-Star® in 2-3 hours, with significantly less product decomposition. This modified synthesis enabled subsequent production of TFE-CDP-Star® in large (i.e., >50 gm) batches.

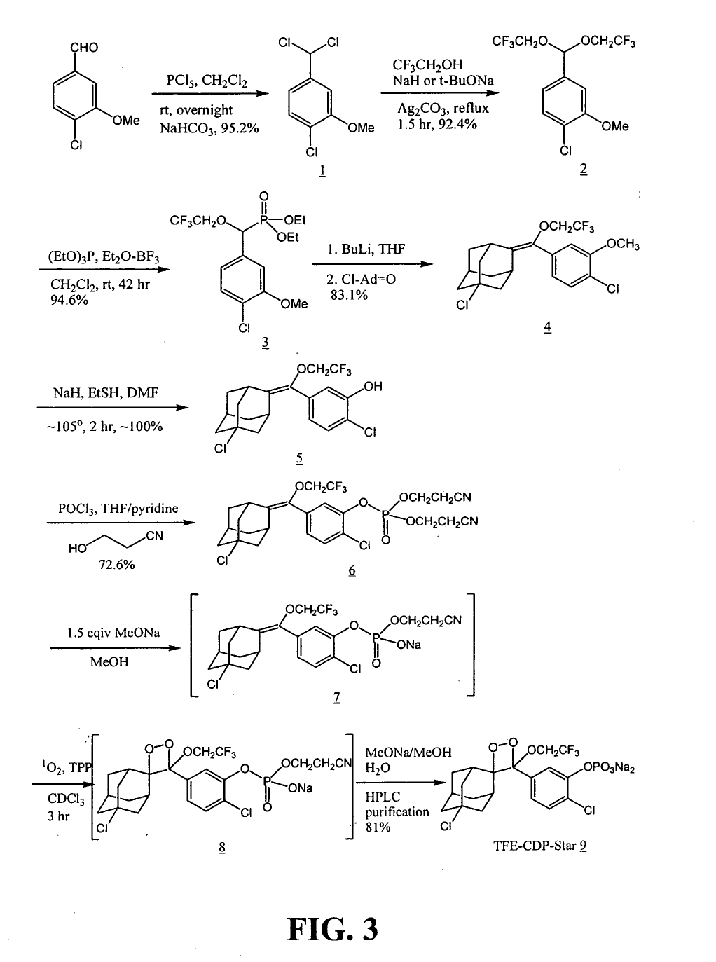

FIG. 3 illustrates steps involved in the synthesis of TFE-CDP-Star according to various embodiments of the invention. Each of these steps is described in detail below. The intermediates (1)-(8) and final product (9) are labeled in FIG. 3 and the following description. Although aspects of the present teachings may be further understood in light of the following examples, these examples should not be construed as limiting the scope of the present teachings in any way.

1-Chloro-4-dichloromethyl-2-methoxy-benzene (1)

Powdered PCl₅ (27.45 g, 0.15 mole) was added under argon to 4-chloro-3-methoxybenzaldehyde (16 g, 94.1 mmole) in five portions; an exothermic reaction was noticed and the mixed solids melted. A water bath was used occasionally to maintain the reaction at room temperature. After the addition of PCl₅ was completed, the mixture was stirred for 5 minutes, followed by addition of 66 ml CH₂Cl₂. The resulting white suspension in a yellow solution was stirred overnight at room temperature. TLC after 20 hours showed the reaction was nearly complete; a less polar spot (rf=0.41 in 5% EtOAc/hex) was the major product. The reaction was quenched cautiously with saturated NaHCO₃ solution at 0° C.; the mixture foamed with an exotherm. Powdered NaHCO₃ was then added until the aqueous solution became alkaline. A white solid in the organic layer was filtered off and rinsed with CH₂Cl₂, combining the rinses with the filtrate. The two-phase filtrate was poured into a separatory funnel. After the organic layer separated, the aqueous layer was drained off and extracted twice with CH₂Cl₂. The combined organic layers were washed with H₂O, dried over anhydrous Na₂SO₄ and concentrated, to yield 23.79 g of a yellow oil.

The crude product was purified by a silica gel plug filtration (column: 5×38 cm), eluting with 0˜4% EtOAc/hexanes by gravity. The separation was reasonably good, affording 20.2 g (95.2%) of the dichloroacetal 1 as a nearly colorless oil.

IR (CHCl₃, cm⁻¹): 1598, 1590, 1492, 1468, 1415, 1290, 1262, 1068 and 1032. No starting material benzaldehyde absorption at 1690˜1706 was detected. ¹H NMR (CDCl₃, ppm): δ 7.37 (1H, d J=8.2 Hz, H-5), 7.18 (1H, d, J=2 Hz, H-2), 7.06 (1H, dd, J=8.2, 2 Hz, H-6), 6.67 (1H, s) and 3.96 (3H, s, OMe).

4-Chloro-3-methoxybenzaldehyde bis-(2,2,2-trifluoroethyl)acetal (2)

NaH (60% in mineral oil, 8.06 g, 0.2 mole) was washed 3 times (3×30 ml) with hexanes under an argon atmosphere. Two equivalents of 2,2,2-trifluoroethanol (13 ml, 0.18 mole) were slowly added at 0° C., generating hydrogen gas immediately as observed from an attached gas bubbler. The suspended mixture became viscous and the magnetic stirring bar was unable to spin at the end of addition. After the first addition of 13 ml 2,2,2-trifluoroethanol, an additional 2,2,2-trifluroethanol (87 ml) was carefully poured into the reaction vessel down the vessel walls; violent evolution of hydrogen gas occurred several times. Finally, the reaction stirred freely and a milky suspension resulted.

1-Chloro-4-dichloromethyl-2-methoxy-benzene 1 (20.2 g, 89.5 mmole) was added rapidly to the above sodium 2,2,2-trifluoroethoxide suspension through a syringe at 0° C. 2,2,2-Trifluoroethanol (26 ml) was used to rinse the syringe and added to the mixture. Vacuum-dried silver carbonate (49.9 g, 179 mmole) was then added in one portion to the solution. Following immediate removal of the ice bath, the suspended mixture was stirred at room temperature for 5 minutes, then heated at 80˜85° C. (bath temperature) for 90 minutes. The mixture became viscous again during the reaction. More 2,2,2-trifluoroethanol (54 ml) was added to keep the reaction stirring smoothly. The mixture was cooled and diluted with EtOAc. Some solid was filtered off and rinsed with EtOAc, combining the rinses with the filtrate. After concentration of filtrate, a cloudy oil was obtained.

The crude product was partitioned between saturated NaHCO₃ solution and 10% EtOAc/hex, the aqueous layer was extracted two more times with 10% EtOAc/hex. The combined organic layer was washed with H₂O and dried over anhydrous Na₂SO₄. After concentration of the solution, 32.63 g of a light yellow oil was obtained.

The impure product was purified by a silica gel plug filtration (column: 5×38 cm), eluting with 0˜4% EtOAc/hex by gravity to afford 29.18 g (92.4%) of the TFE acetal 2 as a nearly colorless oil, which solidified in the refrigerator, mp: 29-31° C.

TLC (5% EtOAc/hexanes) showed that 4-chloro-3-methoxybenzaldehyde was the only byproduct. Its spot (rf=0.23) exhibited a nearly similar UV intensity as the TFE acetal 2 (rf=0.40). Based on the excellent yield of the reaction, the TFE acetal 2 apparently had a weak UV activity.

IR (CHCl₃, cm⁻¹): 2950, 1602, 1590, 1490, 1466, 1412, 1280, 1170, 1120, 1070, 1032, 967 and 870. A very weak absorption of benzaldehyde at 1705 was detected.

1H NMR (CDCl₃, ppm): δ 7.41 (1H, dd, J=6.9, 1.8 Hz), 7.02˜7.05 (2H, m), 5.84 (1H, s), 3.80˜3.98 (6H, m), 3.92 (3H, s).

As shown in FIG. 3, t-BuONa can be used in place of NaH as set forth below. The reaction using this alternate base proceeded smoothly.

4-Chloro-3-methoxybenzaldehyde bis-(2,2,2-trifluoroethyl)acetal (2)-alternative Synthesis

A 250 ml round-bottomed flask was charged with sodium t-butoxide (0.94 g, 9.7 mmole) under an argon atmosphere. 2,2,2-Trifluoroethanol (20 ml) was added slowly to the flask at 0° C. After 30 minutes of stirring, a clear solution was obtained. The resulting sodium 2,2,2-trifluoroethoxide was treated with 1-chloro-4-dichloromethyl-2-methoxy-benzene 1 (1.0 g, 4.4 mmole) and silver carbonate (2.4 g, 8.8 mmole) sequentially. Additional 10 ml of 2,2,2-trifluoroethanol was used to rinse down the powder to the solution. Upon removal of the ice bath, the slurry was stirred at room temperature for 5 minutes and refluxed for 90 minutes. The green-yellowish slurry was cooled back to room temperature, diluted with 20 ml of EtOAc and filtered through celite. The nearly colorless filtrate was concentrated on a rotary evaporator to yield a light yellow oil. The crude product was partitioned between 20 ml each of 10% EtOAc in hexanes and saturated NaHCO₃ solution. After the organic phase was separated, the aqueous phase was further extracted with 10% EtOAc in hexanes twice (2×20 ml). The combined organic solution was washed with H₂O, dried over anhydrous Na₂SO₄ and concentrated to afford 1.44 g (92.3%) of the TFE acetal 2 as a pale yellow oil. Analytical HPLC showed the desired acetal 2 in 88% purity, contaminated by 11% of the hydrolyzed 4-chloro-3-methoxybenzaldehyde. The impure product solidified upon storage in the refrigerator.

Diethyl 1-(2,2,2-trifluoroethoxy)-1-(4-chloro-3-methoxyphenyl) methane phosphonate (3)

Boron trifluoride etherate (7.1 ml, 57.7 mmole) was added dropwise to a mixture of the TFE acetal 2 (17.7 g, 50.2 mmole), triethyl phosphite (9.9 ml, 57.7 mmole) and CH₂Cl₂ (70 ml) under argon at −8° C. (salt/ice bath temperature). The resulting mixture was stirred for 100 minutes at −8 to +10° C. and 42 hr at room temperature. The color of the mixture became orange. The reaction was quenched with excess saturated NaHCO₃ solution and stirred at room temperature for an hour. The mixture was extracted with CH₂Cl₂ three times. The combined organic solution was washed with H₂O, dried over anhydrous Na₂SO₄ and concentrated to yield 24.03 g of a light yellow oil.

The crude product was purified by a silica gel plug filtration (column: 5×38 cm), eluting with 10˜60% EtOAc/hexanes by gravity to afford 18.55 g (94.6%) of the slightly impure phosphonate 3 as a light yellow oil.

IR (CHCl₃, cm⁻¹): 3000, 2940, 2910, 1596, 1588, 1488, 1475, 1415, 1278, 1256, 1165, 1115, 1060, 1030, 970.

¹H NMR (CDCl₃, ppm): δ 7.38 (1H, dd, J=8.1, 0.7 Hz), 7.09 (1H, t, J=1.9 Hz), 6.94 (1H, dt, J=8.1, 2 Hz), 4.75 (1H, d, J=15.3 Hz), 3.73˜4.20 (6H, m), 3.93 (3H, s), 1.30 (3H, t, J=7 Hz) and 1.25 (3H, t, J=7 Hz).

2-Chloro-5-{1-(2,2,2-trifluoroethoxy-5′-chloro-tricyclo[3.3.1.1^{3,7}]dec-2-ylidenemethyl)} anisole (4)

Butyllithium (1.6 M in hexanes, 29.7 ml, 47.5 mmole) was added dropwise over 15 minutes to a solution of the phosphonate 3 (18.55 g, 47.5 mmole) stirring in 100 ml of anhydrous THF under argon at −78° C. The resulting deep orange mixture was stirred in at −78° C. for 35 minutes, and then 5-chloro-2-adamantanone powder (7.6 g, 41.3 mmole) was added in one portion over 3 minutes under an argon blanket. The mixture continued to stir at −78° C. for 10 minutes. Upon removal of the cold bath, the mixture was allowed to warm to room temperature over 80 minutes; upon warming the solution became homogeneous and the color changed to light orange. Finally, the mixture was refluxed for an hour (caution: butane outgassing). After cooling to room temperature, the reaction was quenched with saturated NaHCO₃ solution, the mixture was extracted three times with 5% EtOAc/hex (200 ml). The combined organic layers were washed with H₂O, dried over anhydrous Na₂SO₄, and concentrated to yield 21.41 g of a yellow gum.

The crude product was purified by silica gel plug filtration twice, eluting with 2˜4% EtOAc/hexanes to afford 16.06 g of a colorless gum. This slightly impure product was then crystallized twice in MeOH to yield 14.45 g (83.1%) of the TFE enol ether anisole 4 as a white solid, mp: 72-74° C.

IR (CHCl₃, cm⁻¹): showed no hydroxyl or ketonic absorption. Other significant absorptions are 2940, 2860, 1592, 1574, 1486, 1402, 1278, 1160, 1103, 1065, 1024, 963 and 826.

¹H NMR (CDCl₃, ppm): δ 7.37 (1H, d, J=8 Hz, H-3), 6.86 (1H, d, J=1.8 Hz, H-6), 6.81 (1H, dd, J=8, 1.8 Hz, H-4), 3.90 (3H, s), 3.76 (2H, q, J=8.6 Hz), 3.49 (1H, br, s), 2.76 (1H, br, s), 2.09˜2.33 (7H, m) and 1.64˜1.92 (4H, m).

2-Chloro-5-{1-(2,2,2-trifluoroethoxy-5′-chloro-tricyclo[3.3.1.1^{3,7}]dec-2-ylidenemethyl)} phenol (5)

Sodium hydride (60% in mineral oil, 1.28 g, 32 mmole) was washed three times with hexanes under an argon atmosphere. Anhydrous DMF (80 ml) was added, the slurry was cooled to 0° C. in an ice bath. Ethanethiol (2.4 ml, 32.4 mmole) was added dropwise with evolution of hydrogen gas. The clear solution of sodium ethylthiolate was stirred at 0° C. for 10 minutes and room temperature for 50 minutes. After cooling the sodium ethylthiolate solution back to 0° C., the solid TFE enol ether anisole 4 (9 g, 21.4 mmole) was added to the mixture in one portion. The suspended mixture became clear after stirring 15 minutes at room temperature; the solution was then heated for 2 hours at 105˜108° C. (bath temperature). After cooling to room temperature, the mixture was poured into a 500 ml separatory funnel containing saturated NaHCO₃ solution. The aqueous layer was extracted four times with 10% EtOAc/hex (200 ml). The combined organic layer was washed with H₂O, dried over anhydrous Na₂SO₄ and concentrated to yield 10.47 g of an orange gum.

The crude product was purified by silica gel plug filtration, and impure fractions were re-chromatographed twice, affording 8.81 g (>100%) of the slightly impure TFE enol ether phenol 5 as an orange gum.

IR(CHCl₃, cm⁻¹): 3544, 2938, 2858, 1575, 1486, 1318, 1310, 1282, 1170, 1104, 1050, 1024, 966 and 825: ¹H-NMR (CDCl₃, ppm): δ 7.34 (1H, d, J=8.2 Hz, H-3), 6.94 (1H, d, J=1.9 Hz, H-6), 6.81 (1H, dd, J=8.2, 1.9 Hz, H-4), 3.76 (2H, q, J=8.6 Hz), 3.47 (1H, br, s), 2.75 (1H, br, s), 2.08˜2.32 (7H, m) and 1.63˜1.89 (4H, m).

Bis-cyanoethyl [1-Chloro-5-{1-(2,2,2-trifluoroethoxy-5′-chlorotricyclo[3.3.1.1.^{3,7}]dec-2-ylidenemethyl}]phenyl phosphate (6)

Freshly distilled phosphorus oxychloride (2.7 ml, 28.6 mmole) was added dropwise under argon to anhydrous pyridine (26 ml) over 4 minutes at 0° C.; mild white smoke formed but no precipitation was observed. After stirring for 13 minutes at 0° C., the mixture was treated with a solution of the TFE enol ether phenol 5 (7.75 g, 19 mmole) in anhydrous THF (65 ml) through a dropping funnel over 65 minutes. White pyridine hydrochloride precipitation formed during the addition. An additional 5 ml of THF was used to rinse the funnel and added to the mixture. The suspended mixture was stirred for 30 minutes at 0° C. and 3 hours at room temperature. After cooling back to 0° C., freshly distilled 3-hydroxypropionitrile (8.8 ml, 129 mmole) was added dropwise over 5 minutes and the mixture was stirred at room temperature over the weekend (66 hr). The resulting white precipitate was filtered off and rinsed with EtOAc, combining the rinses with the filtrate. The filtrate was concentrated by rotary evaporator and pumped under vacuum to remove most of the pyridine.

The orange residue was partitioned between 50% EtOAc/hexanes and saturated NaHCO₃ solution. The aqueous layer was extracted three times with 50% EtOAc/hexanes. The combined organic layers were washed with saturated NaCl solution, dried over anhydrous Na₂SO₄ and concentrated to yield 12.41 g of an orange gum.

The crude product was purified by silica gel chromatography, eluting first with 20˜30% EtOAc/hexanes to remove the less polar byproduct, then flushing the column with 50˜70% EtOAc/hexanes to recover 8.59 g of the enol ether phosphate triester 6 as a colorless gum. A constant weight of 8.2 g (72.6%) was obtained after prolonged pumping under vacuum.

IR (CHCl₃, cm⁻¹): 3010, 2936, 2858, 2258, 1598, 1568, 1485, 1400, 1270, 1104, 1045, 1005, 983, 970, 924 and 828.

¹H NMR (CDCl₃, ppm): δ 7.48 (1H, dd, J=8.2, 1 Hz), 7.37 (1H, t, J=1.5 Hz), 7.10˜7.13 (1H, m), 4.41˜4.51 (4H, m), 3.78 (2H, q, J=8.6 Hz), 3.47 (1H, br, s), 2.84 (4H, t, J=6 Hz), 2.76 (1H, br,s), 2.13˜2.30 (7H, m) and 1.72˜1.89 (4H, m).

Disodium 2-chloro-5-(2,2,2-trifluoroethoxyspiro[1,2-dioxetane-3,2′-(5-chloro)-tricyclo-[3.3.1.1^{3,7}]decan]-4yl)-1-phenyl phosphae (TFE-CDP-Star) (9).

A solution of bis-cyanoethyl [2-chloro-5-{1-(2,2,2-trifluoroethoxy-5′-chloro-tricyclo[3.3.1.1^{3,7}]dec-2-ylidenemethyl}]phenyl phosphate 6 (2.3 g, 3.9 mmole) in 4 mL of MeOH was treated with 1.0 - 1.5 equiv. of 25 wt. % MeONa in MeOH (4.37 M, 5.8 mmole, 1.3 ml), depending on acidic impurities, at room temperature for 30 minutes. The MeONa/MeOH treatment hydrolyzed one cyanoethyl group to generate the more electron-rich monosodium phosphate diester enol ether intermediate 7. To the resulting solution of the monocyanoethylphosphate diester enol ether 7 was added 4 ml of TPP stock solution (2 mg/ml CHCl₃), and the solution was pumped under vacuum to remove MeOH until a purple gum was obtained. The residue was re-dissolved in 44 ml of CDC1₃ and irradiated with a 400 W sodium vapor lamp while continuously bubbling oxygen through the solution at 0° C. to generate ¹O₂.

Based on previous experience in the CDP-Star synthesis, we knew that a simple MeONa/MeOH treatment (in excess) of a mid-reaction aliquot at room temperature induces full β-elimination of cyanoethyl ester phosphates to give chloroadamantyl enol ether phosphate disodium salt obtained from the unreacted starting material 7 and TFE-CDP-Star. However, these two phosphate disodium salts co-eluted on reverse phase analytic HPLC, despite using several different programs, making confirmation of the reaction endpoint difficult. To distinguish the desired product (TFE-CDP-Starg 9) from the reactant monocyanoethylphosphate diester enol ether 7 and to confirm completion of the photooxygenation, a small reaction aliquot was reacted with excess 0.5 M NaOH aqueous solution at 38° C. for 6 hours; the chloroadamantyl enol ether phosphate disodium salt 7 underwent chloro to hydroxy exchange to form the hydroxyadamantyl enol ether phosphate disodium salt analogue, which eluted earlier at 7.6 min in a gradient of 5-10% CH₃CN in 0.1% NaHCO₃ solution on HPLC. No chloro to hydroxy group exchange occurred on TFE-CDP-Star, which eluted at 12.8 min.

After 3 hours of photooxygenation, the area integrals of the 7.6 min peak (hydroxy-exchanged starting enol ether 7) and the 12.8 min peak (TFE-CDP-Star) were 5.8% and 84.2%, respectively. The use of the deuterated solvent CDCl₃, which increases the half-life of singlet oxygen, and removal of one cyanoethyl group from the starting material phosphate triester 6 prior to photooxygenation, significantly accelerated dioxetane formation and minimized dioxetane decomposition. To achieve a similar conversion on 0.5 g of phosphate triester 6 required more than 12 hours photooxygenation in CHCl₃ with less product yield.

The bulk reaction mixture was concentrated on a rotary evaporator at low temperature. The residue was dissolved in 20 ml of MeOH and treated with 16% excess of 25 wt. % MeONa in MeOH (4.5 mmole, 1 ml) at room temperature for an hour. The mixture was diluted with 45 ml of H₂O. TPP dye was removed by filtration, the filtrate was purified by HPLC equipped with a PLRP-S one-inch column, eluting with a gradient of 10-80% CH₃CN in H₂O. The dioxetane fractions were pooled and lyophilized, to give 1.77 g (81%) of TFE-CDP-Star 9 as a white powder.

Various exemplary embodiments are described below.

According to some embodiments, a method of making 1,2-dioxetane compound is provided wherein the dioxetane compound has a structure represented by the formula (I): 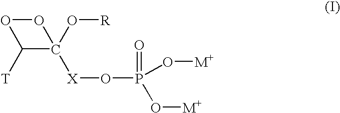
wherein R is an alkyl, aryl, aralkyl or cycloalkyl group having 1-20 carbon atoms optionally comprising 1-5 halogen atoms each independently either F, Cl, Br or I; T is a stabilizing group; M is an alkali metal or ammonium, pyridinium or peralkylammonium group; and X is an aromatic light-emitting fluorophore-forming group capable of absorbing energy to form an excited energy state from which it emits optically detectable energy to return to its original energy state. The method comprises oxidizing a compound having the formula (II): 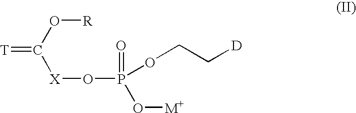
to form a dioxetane intermediate compound represented by the formula (III): 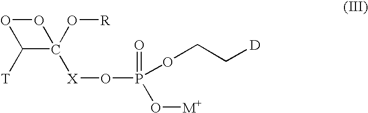
and reacting the dioxetane intermediate compound (III) with a base to form the 1,2-dioxetane compound (I). The substituent D in the above embodiments is chosen such that the proton alpha to D is acidic and can be deprotonated by a base resulting in beta-elimination of the ethyl-D group as an ethylene-D group thereby leaving an oxyanion or hydroxyl group.

According to the aforementioned embodiments, the inorganic or organic base can be a compound comprising an alkali metal (e.g., sodium, lithium or potassium) and a hydroxyl group (e.g., hydroxides or alkoxides). Exemplary bases include, but are not limited to, alkali metal hydroxides such as sodium hydroxide and alkali metal alkoxides such as sodium methoxide and sodium ethoxide. In addition, T can be spiro bonded to the carbon atom of the dioxetane ring. Further, R can be an electron withdrawing group. For example, R can comprise at least one halogen substituent. D can be CN, N(R′)₃⁺, S(O)₂R′, S(O)₂Ar, nitrophenyl, or dinitrophenyl wherein R′ represents an alkyl group and Ar represents an aryl group.

The dioxetane intermediate compound (III) in the above embodiments can be reacted with a base to form the 1,2-dioxetane compound (I). Suitable bases include, but are not limited to, MeONa (sodium methoxide), NH₄OH, NH₃, NaOH, KOH, DBU (1,8-diazabicyclo[5.4.0]undec-7-ene), or a tertiary amine base. The substituent M can be Na. The substituent R can be —CH₂CF₃.

Also according to the above embodiments, the dioxetane compound (I) can have a formula represented by: 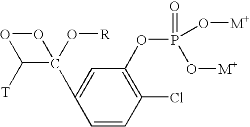
Alternatively, the dioxetane compound (I) can have a formula represented by:

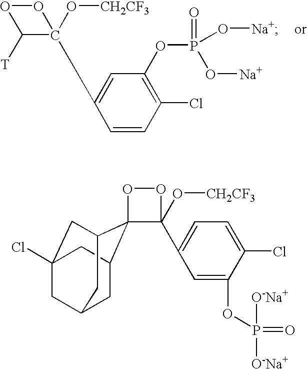

According to any of the above embodiments, the method can further comprise: reacting a compound having the formula (IV): 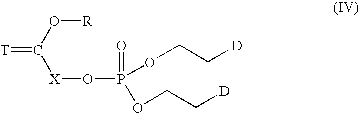
with a base to form the compound (II). The substituent D can be a cyano group. The substituent T can be an adamantyl group or a 5-chloroadamantyl group. The dioxetane intermediate compound (IV) can be reacted with a base to form the compound (II). Suitable bases include, but are not limited to, MeONa (sodium methoxide), NH₄OH, NH₃, NaOH, KOH, DBU (1,8-diazabicyclo[5.4.0]undec-7-ene) or a tertiary amine base. The method can further comprise reacting a compound having the formula (V): 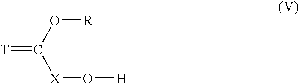
with POCl₃ and OH—CH₂—CH₂—D to form the compound (IV). The method can further comprise reacting a compound having the formula (VI): 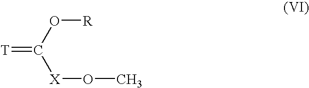
with sodium hydride and ethanethiol to form the compound (V). The compound having the formula (VI) can be represented by the formula: 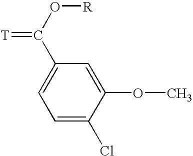
wherein the method further comprises reacting a compound (VII): 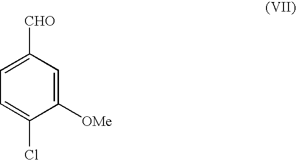
with PCl₅ to form a compound (VIII): 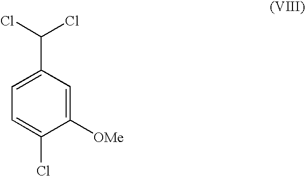
reacting the compound (VIII) with CF₃CH₂OH, Ag₂CO₃ and either NaH or t-BuONa to form a compound (IX): 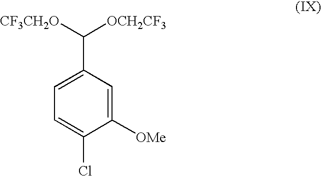
and reacting the compound (IX) with (EtO)₃P and Et₂O—BF₃ to form a compound (X): 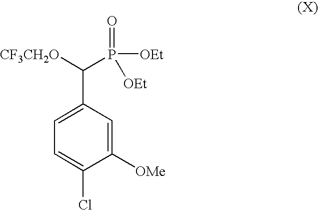
and reacting the compound (X) with T═O to form the compound (VI).

According to some embodiments of the invention, a dioxetane compound having the formula: 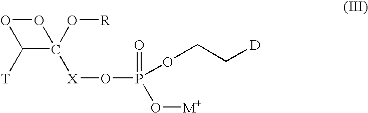
is provided wherein R is an alkyl, aryl, aralkyl or cycloalkyl group having 1-20 carbon atoms optionally comprising 1-5 halogen atoms each independently either F, Cl, Br or I; T is a stabilizing group; M is an alkali metal, ammonium, pyridinium or peralkylammonium group; X is an aromatic, light-emitting fluorophore-forming group capable of absorbing energy to form an excited energy state from which it emits optically detectable energy to return to its original energy state, and wherein D is chosen such that the proton alpha to D is acidic and can be deprotonated by a base resulting in beta-elimination of the ethyl-D group as an ethylene-D group thereby leaving an oxyanion or hydroxyl group. The substituent T can be an adamantyl group or a 5-chloroadamantyl group. The substituent R can be an electron withdrawing group. For example, R can comprise at least one halogen substituent (e.g., R can be —CH₂CF₃). The substituent D can be —CN, (NR′)₃⁺, S(O)₂R′, S(O)₂Ar, nitrophenyl, or dinitrophenyl, wherein R′ represents an alkyl group and Ar represents an aryl group. The substituent M can be Na.

The dioxetane compound (III) can have a formula represented by: 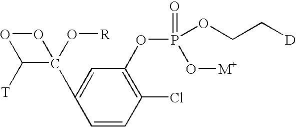
The substituent D in the above formula can be a cyano group. The substituent T in the above formula can be a spiro bonded adamantyl group or a 5-chloroadamantyl group.

The dioxetane compound (III) can have a formula represented by: 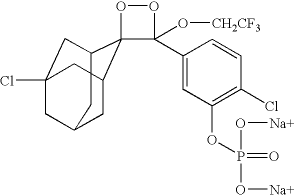
The substituent D in the above formula can be a cyano group. The substituent T in the above formula can be a Spiro bonded adamantyl group or a 5-chloroadamantyl group.

The dioxetane compound (III) can have a formula represented by: 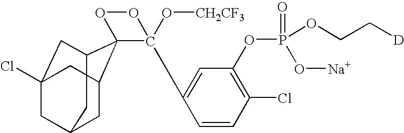
The substituent D in the above formula can be a cyano group.

The section headings used in this application are for organizational purposes only and are not to be construed as limiting the subject matter in any way.

While foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A method of making a 1,2-dioxetane compound having a structure represented by the formula (I): 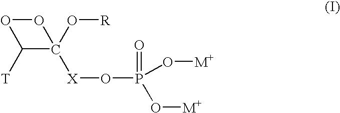
wherein R is an alkyl, aryl, aralkyl or cycloalkyl group having 1-20 carbon atoms optionally comprising 1-5 halogen atoms independently selected from the group consisting of F, Cl, Br and I; T is a stabilizing group; M is an alkali metal; and X is an aromatic, light-emitting fluorophore-forming fluorescent chromophore group capable of absorbing energy to form an excited energy state from which it emits optically detectable energy to return to its original energy state; the method comprising:
oxidizing a compound having the formula (II): 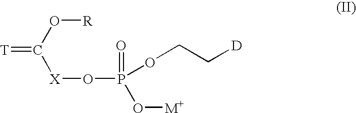
to form a dioxetane intermediate compound represented by the formula (III): 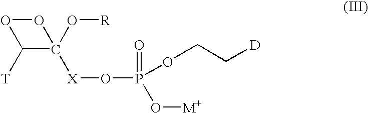
and;
reacting the dioxetane intermediate compound (III) with a base to form the 1,2-dioxetane compound (I);
wherein D is chosen such that the proton alpha to D is acidic and can be deprotonated by a base resulting in beta-elimination of the ethyl-D group as an ethylene-D group thereby leaving an oxyanion or hydroxyl group.

2. The method of claim 1, wherein the base comprises an alkali metal and a hydroxyl group.

3. The method of claim 1, wherein T is spiro bonded to the carbon atom of the dioxetane ring.

4. The method of claim 1, wherein R is an electron withdrawing group.

5. The method of claim 4, wherein R comprises at least one halogen substitutent.

6. The method of claim 1, wherein D is selected from the group consisting of —CN, NR₃⁺, S(O)₂R, S(O)₂Ar, nitrophenyl, or dinitrophenyl wherein R represents an alkyl group and Ar represents an aryl group.

7. The method of claim 1, wherein the base is selected from the group consisting of sodium methoxide, NH₄OH, NH₃, NaOH, KOH, DBU (1,8-diazabicyclo[5.4.0]undec-7-ene) and amine bases.

8. The method of claim 1, wherein M is Na.

9. The method of claim 1, wherein R is —CH₂CF₃.

10. The method of claim 1, wherein the dioxetane compound (I) has a formula represented by:

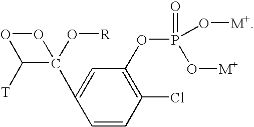

11. The method of claim 1, wherein the dioxetane compound (I) has a formula represented by:

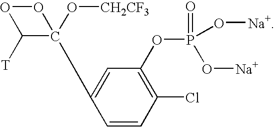

12. The method of claim 1, wherein the dioxetane compound (I) has a formula represented by:

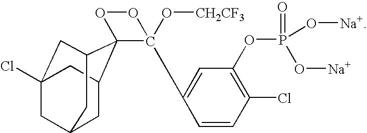

13. The method of claim 1, further comprising:
reacting a compound having the formula (IV): 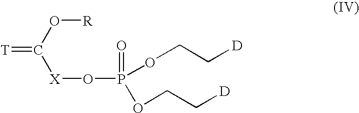
with a base to form the compound (II).

14. The method of claim 13, wherein the compound having the formula (IV) is reacted with a base comprising an alkali metal and a hydroxyl group to form the compound (II).

15. The method of claim 13, wherein each D in the compound (IV) is a cyano group.

16. The method of claim 13, wherein T in the compound (IV) is an adamantyl group or a 5-chloroadamantyl group.

17. The method of claim 13, wherein the dioxetane intermediate compound (IV) is reacted with a base selected from the group consisting of sodium methoxide, NH₄OH, NH₃, NaOH, KOH, amine bases, DBU (1,8-diazabicyclo[5.4.0]undec-7-ene) and amine bases.

18. The method of claim 13, wherein the dioxetane intermediate compound (IV) is reacted with sodium methoxide to form the compound (II).

19. The method of claim 13, further comprising
reacting a compound having the formula (V): 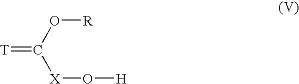
with POCl₃ and OH—CH₂—CH₂—D to form the compound (IV).

20. The method of claim 19, further comprising
reacting a compound having the formula (VI): 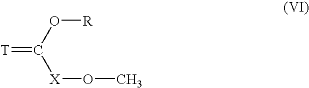
with sodium hydride and ethanethiol to form the compound (V).

21. The method of claim 20, wherein the compound having the formula (VI) is represented by the formula: 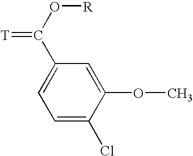
the method further comprising reacting a compound (VII): 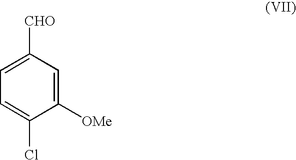
with PCl₅ to form a compound (VIII): 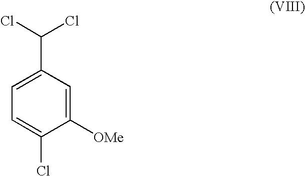
reacting the compound (VIII) with CF₃CH₂OH, Ag₂CO₃ and either NaH or t-BuONa to form a compound (IX): 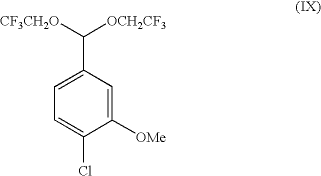
and reacting the compound (IX) with (EtO)₃P and Et₂O—BF₃ to form a compound (X): 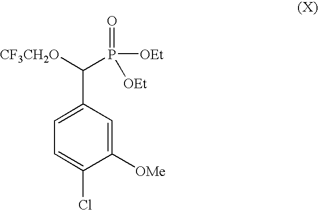
and reacting the compound (X) with T═O to form the compound (VI).

22. A dioxetane compound having the formula: 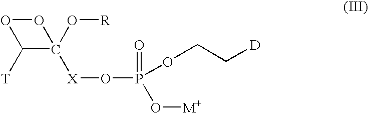
wherein R is an alkyl, aryl, aralkyl or cycloalkyl group having 1-20 carbon atoms optionally comprising 1-5 halogen atoms independently selected from the group consisting of F, Cl, Br and I; T is a stabilizing group; M is an alkali metal; X is an aromatic, light-emitting fluorophore-forming fluorescent chromophore group capable of absorbing energy to form an excited energy state from which it emits optically detectable energy to return to its original energy state and wherein D is chosen such that the proton alpha to D is acidic and can be deprotonated by a base resulting in beta-elimination of the ethyl-D group as an ethylene-D group thereby leaving an oxyanion or hydroxyl group.

23. The method of claim 22, wherein D is a cyano group.

24. The method of claim 22, wherein T is an adamantyl group or a 5-chloroadamantyl group.

25. The compound of claim 22, wherein R is an electron withdrawing group.

26. The compound of claim 25, wherein R comprises at least one halogen substitutent.

27. The method of claim 22, wherein D is selected from the group consisting of —CN, NR₃⁺, S(O)₂R, S(O)₂Ar, nitrophenyl, or dinitrophenyl wherein R represents an alkyl group and Ar represents an aryl group.

28. The compound of claim 22, wherein M is Na.

29. The compound of claim 22, wherein R is —CH₂CF₃.

30. The compound of claim 22, wherein the dioxetane compound (III) has a formula represented by:

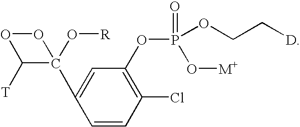

31. The compound of claim 30, wherein D is a cyano group.

32. The method of claim 30, wherein T is an adamantyl group or a 5-chloroadamantyl group.

33. The compound of claim 22, wherein the dioxetane compound (III) has a formula represented by:

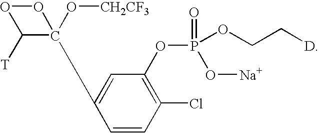

34. The compound of claim 33, wherein D is a cyano group.

35. The compound of claim 33, wherein T is an adamantyl group or a 5-chloroadamantyl group.

36. The compound of claim 22, wherein the dioxetane compound (III) has a formula represented by:

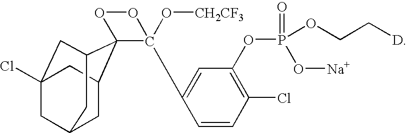

37. The compound of claim 36, wherein D is a cyano group.

38. A compound of the following general formula: 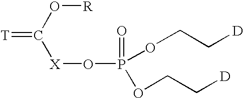
wherein R is an alkyl, aryl, aralkyl or cycloalkyl group having 1-20 carbon atoms optionally comprising 1-5 halogen atoms independently selected from the group consisting of F, Cl, Br and I; T is a stabilizing group; and X is an aromatic, light-emitting fluorophore-forming fluorescent chromophore group capable of absorbing energy to form an excited energy state from which it emits optically detectable energy to return to its original energy state, and wherein D is chosen such that the proton alpha to D is acidic and can be deprotonated by a base resulting in beta-elimination of the ethyl-D group as an ethylene-D group thereby leaving an oxyanion or hydroxyl group.

39. A compound according to claim 38 having the structure:

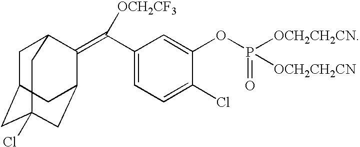

40. A compound represented by the formula (III): 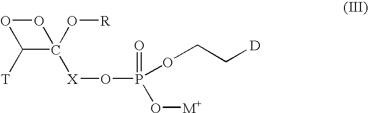
wherein R is an alkyl, aryl, aralkyl or cycloalkyl group having 1-20 carbon atoms comprising 1-5 halogen atoms independently selected from the group consisting of F, Cl, Br and I; T is a stabilizing group; M is an alkali metal; and X is an aromatic, light-emitting fluorophore-forming fluorescent chromophore group capable of absorbing energy to form an excited energy state from which it emits optically detectable energy to return to its original energy state, and wherein D is chosen such that the proton alpha to D is acidic and can be deprotonated by a base resulting in beta-elimination of the ethyl-D group as an ethylene-D group thereby leaving an oxyanion or hydroxyl group.

41. The compound of claim 40, wherein R is —CH₂CF₃.

42. A compound according to claim 40 having the structure:

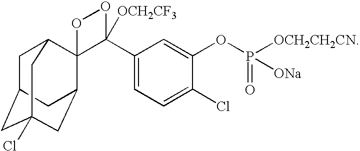

43. A compound represented by the formula (II): 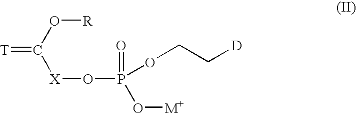
wherein R is an alkyl, aryl, aralkyl or cycloalkyl group having 1-20 carbon atoms comprising 1-5 halogen atoms independently selected from the group consisting of F, Cl, Br and I; T is a stabilizing group; M is an alkali metal; and X is an aromatic, light-emitting fluorophore-forming fluorescent chromophore group capable of absorbing energy to form an excited energy state from which it emits optically detectable energy to return to its original energy state, and
wherein D is chosen such that the proton alpha to D is acidic and can be deprotonated by a base resulting in beta-elimination of the ethyl-D group as an ethylene-D group thereby leaving an oxyanion or hydroxyl group.

44. The compound of claim 43, wherein R is —CH₂CF₃.

45. A compound according to claim 43 having the structure: [chemical structure]
